(19) United States
(12) Patent Application Publication
(10) Pub. No.: US 2024/0375949 A1
(43) Pub. Date: Nov. 14, 2024

(54) PLANT AND METHOD FOR THE PRODUCTION OF DECARBONIZED HYDROGEN USING CARBONATE, GAS CONTAINING HYDROCARBONS AND ELECTRICITY

(71) Applicant: HYROGAS SIA, Marupe (LV)

(72) Inventor: Giovanni CAPPELLO, Galbiate (IT)

(21) Appl. No.: 18/292,988

(22) PCT Filed: Jul. 28, 2022
(86) PCT No.: PCT/IB2022/056974

§ 371 Date: Jan. 29, 2024

(30) Foreign Application Priority Data
Jul. 29, 2021 (IT) 102021000020225

(51) Int. Cl. C01B 3/06; C01B 3/16; C01F 11/02

(52) U.S. Cl. CPC C01B 3/068; C01B 3/16; C01F 11/02; C01B 2203/0283; C01B 2203/06; C01B 2203/169

(57) ABSTRACT

The invention relates to a plant and a method for the production of decarbonised hydrogen using carbonate, water, gas containing hydrocarbons and electricity. The plant 100 first of all comprises an electric calciner 10, a contactor 20, an apparatus for correcting the pH 30 and a metering device 40. The plant 100 is suitable for receiving electrical energy, carbonate, water, natural gas at its input and for releasing decarbonised hydrogen at its outlet and an alkaline water rich in bicarbonates which, once released into the sea, represents the permanent storage for CO₂. The plant 100 uses bicarbonates as permanent storage of CO₂ in the sea: this storage allows the production of decarbonised hydrogen at low costs and in modular plants.

The present invention relates to a method and a system for the production of decarbonized hydrogen using carbonate, gas containing hydrocarbons and electricity.

The effects of so-called “greenhouse gases” on the climate have long been known, and above all the correlation between the concentration in the atmosphere of CO₂ (carbon dioxide) and global warming.

The efforts of the scientific community and world politics in recent years have been concentrated in the attempt to counteract the increase in greenhouse gas emissions into the atmosphere, to avoid the phenomenon of global warming, that is, the increase in the average temperature at a global level.

In a known way, many initiatives aimed at limiting CO₂ emissions into the atmosphere have been promoted at an international level: among others, the Kyoto Protocol in 1997 and the Paris Agreement in 2015 deserve to be mentioned.

The forms identified by the scientific community to avoid global warming are many and substantially concern the decrease in the use of fossil fuels such as coal, oil and natural gas favoring the development of renewable energies such as hydraulic, wind, solar, biomass and of zero-emission fuels such as hydrogen or ammonia.

Furthermore, many efforts of the international community are focused towards improving the efficiency of energy uses, as in the case of lighting with low consumption lamps, towards transport with new generation of high efficiency motors and, in the field of electricity generation, towards the replacement of old and inefficient coal or fuel oil plants with new combined cycle plants with gas turbine and steam turbine, with energy yields close to 60%.

Despite the technological effort underway in the most advanced nations, the forecasts of well-known international institutions on the need for energy globally in the coming years indicate a sharp increase in the demand for electricity, thermal energy for industry and fuel for transportation.

Consequently, these forecasts indicate a steady increase in other uses of fossil fuels such as oil, coal and natural gas, especially by emerging, newly industrialized and developing countries. This consumption is in fact favored by the enormous availability of these resources and by the discovery of new deposits and techniques for their extraction, factors which on the whole make these sources of energy economically advantageous.

Using the data provided by these authoritative studies, not only is a decrease in CO₂ emissions globally not expected to combat global warming, but a substantial increase in CO₂ emissions is instead expected over the next 50 years, mainly due to the increase in the world population and to the new industrialization of entire countries.

The catastrophic effects of this situation on the climate are easily understood and difficult to avoid especially because developing nations believe that the renewable energy option is too sophisticated and expensive and are oriented more to short-term economic development programs than to containment. CO₂ emissions and environmental issues.

One of the sectors that will be subject to the future decarbonization of the economy is the transport sector.

The transport sector, which also includes the maritime transport, the air transport and the heavy road transport, are difficult to electrify as they require high energy densities and large autonomies that are not compatible with the known technologies of electricity storage so far known.

Hydrogen or synthetic fuels that use it such as methanol, ammonia, or synthetic fuels from Fischer Tropsch, are the best candidates for the decarbonization of heavy, naval and air transport.

It is therefore essential to have zero-emission sources of hydrogen to decarbonize the transport sector.

In known form there is the possibility of producing hydrogen by hydrolysis of water using renewable or nuclear electricity but with high costs of electricity and plant costs. In particular, the electrical consumption to produce 1 kg of hydrogen from electrolysis is about 50 kWhe.

The cheapest and most used process to produce hydrogen is that of steam methane reforming (SMR) of natural gas which, however, has the problem of emitting about 10 kgCO₂/kgH₂.

Different technologies have been proposed to be able to produce hydrogen from SMR (steam methane reforming) with CO₂ capture to exploit its low production cost but with all the technologies proposed, the problem of permanent storage of CO₂ emissions produced in the process remains.

In a known way, CO₂ capture and storage technologies are commonly called CCS (Carbon Capture and Storage).

The main proposed and known CCS (Carbon Capture and Sequestration) technologies are:
the sequestration of CO₂ in deep saline aquifers, a method recognized and promoted by the European Union through a specific directive of 2009;
the sequestration of CO₂ directly on the ocean floor, in liquid form;
the sequestration of CO₂ in calcium carbonates or calcium silicates, direct or with other uses of peptoids, known as Mineral Carbonation;
the sequestration of CO₂ in oil wells where it is injected to increase the oil production of the well itself with a technology called EOR (enhanced oil recovery);
the sequestration of CO₂ in the form of alkaline earth metal bicarbonates such as calcium and magnesium bicarbonate.

Although there are various technological alternatives available, one of the most important problems still to be solved is the prohibitive cost of CO₂ capture and the limited availability of permanent storage of the CO₂ produced to offer decarbonized hydrogen to the market.

As can be immediately understood, there is a need to identify a technology that allows the production of hydrogen to be achieved through the SMR process, and in general through HSR (Hydrocarbon Steam Reforming) processes with simple technologies and to solve the problem at an acceptable cost. the problem of the permanent storage of CO₂.

The object of the present invention is to make available a method and a system that can allow the efficient generation of hydrogen by means of the HSR of gas containing hydrocarbons with permanent storage of CO₂ with lower costs than known technologies. This object and these tasks are achieved by means of a

system and a method for the production of hydrogen according to claim 1.

In order to better understand the invention and appreciate its advantages, some exemplary and non-limiting embodiments thereof are described below, with reference to the attached drawings, in which:

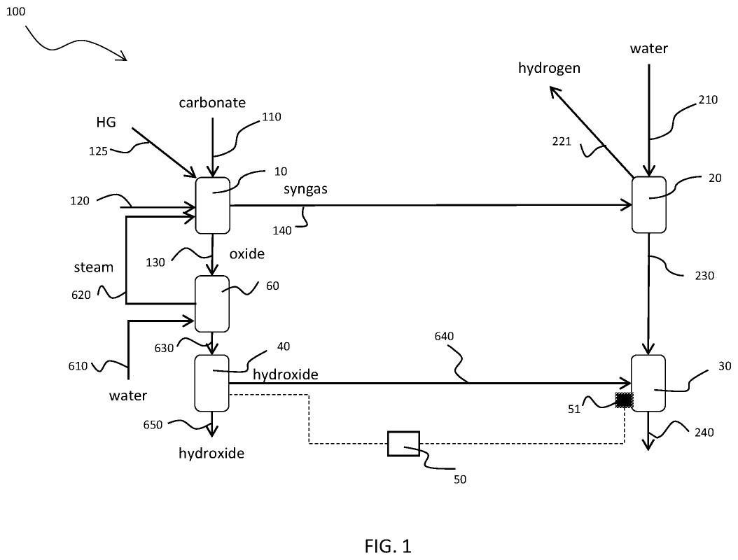

the FIG. 1 is a schematic view of a plant for the production of decarbonized hydrogen complete with a system for measuring and regulating the quality of the acidic water released into the sea according to the invention;

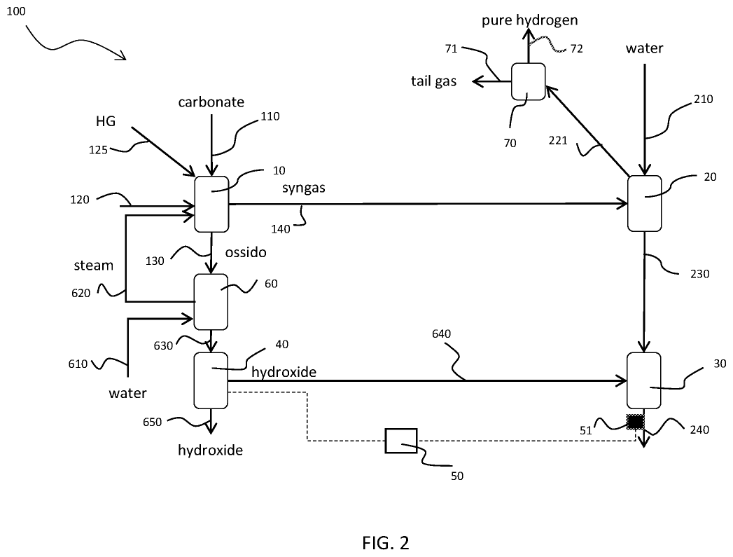

the FIG. 2 is a schematic view of a possible embodiment of the plant for the production of decarbonized hydrogen complete with hydrogen purification system;

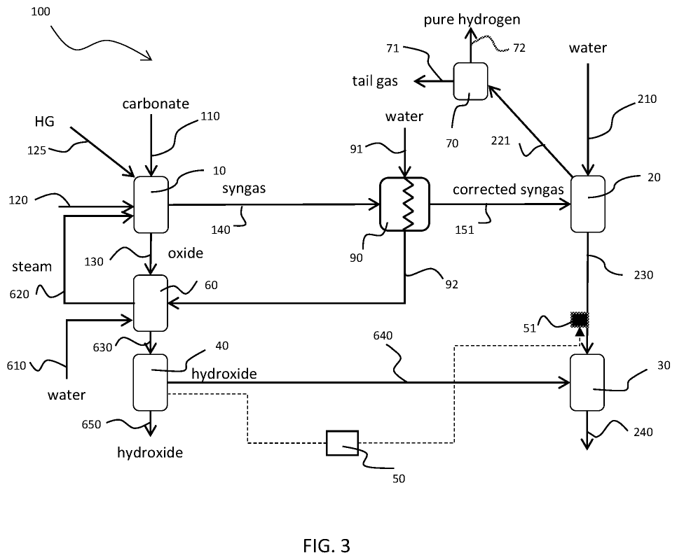

the FIG. 3 is a schematic view of a possible embodiment of the plant for the production of decarbonized hydrogen comprising a WGS reactor according to the invention;

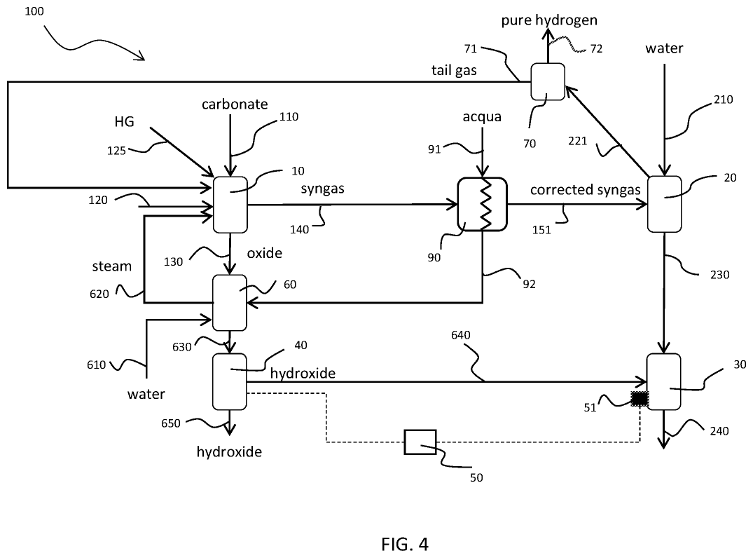

FIG. 4 is a schematic view of a possible embodiment of the plant for the production of decarbonized hydrogen in which the tail gas is recirculated inside the calciner according to the invention;

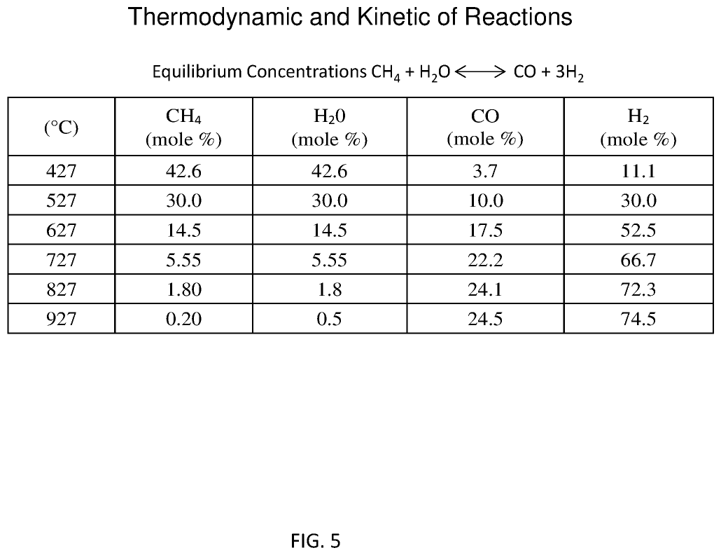

the FIG. 5 is a table with the gas equilibrium values in a non-catalyzed SMR reactor available in the literature;

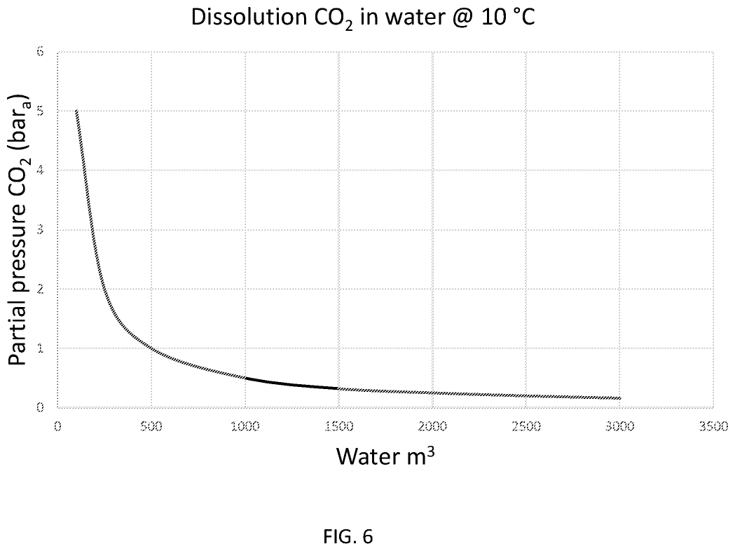

FIG. 6 is a graph with the trend of the minimum partial pressure of CO₂ to have a complete dissolution in different quantities of sea water and at a temperature of 10° C.;

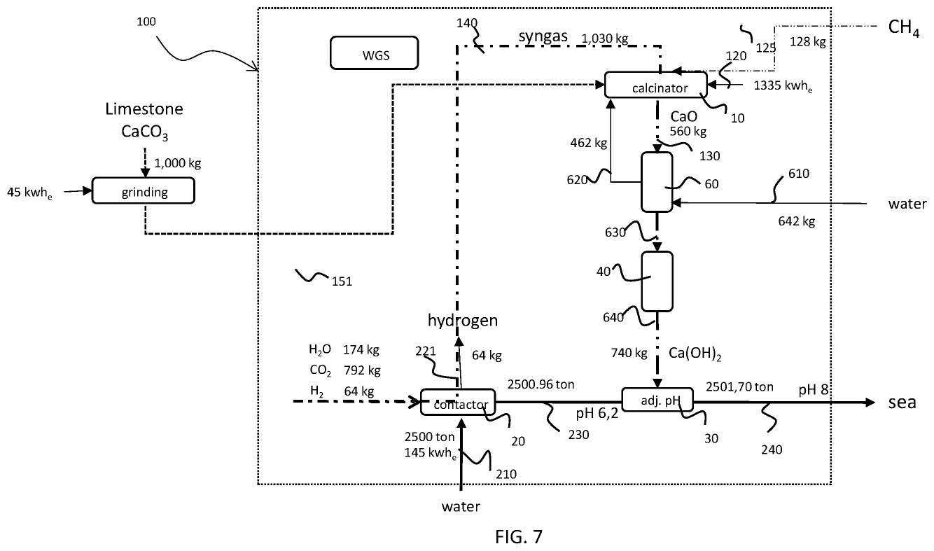

FIG. 7 is a mass and energy balance for 1000 kg of carbonate;

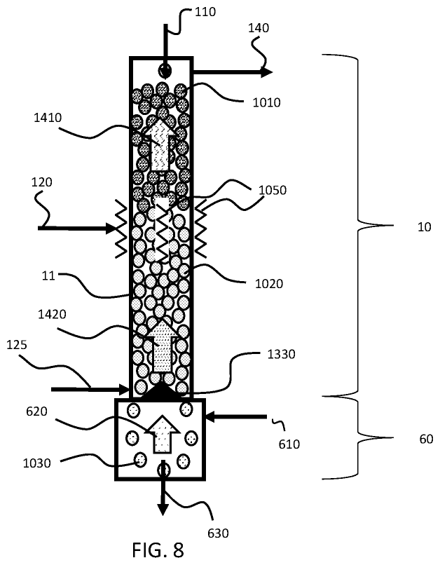

FIG. 8 is a schematic view of a possible embodiment of an electric calciner integrated with a unit for the production of hydroxide.

In the description reference will also be made to “carbon dioxide”, meaning by this a gas containing mainly CO₂, and possibly other substances including N₂, O₂, H₂O, Ar, while when it is intended to refer only to the chemical element CO₂ (carbon dioxide) in the description we will use CO₂.

In the description reference will also be made to “insoluble” gases, meaning by this the set of gases that are not very soluble in water including H₂, CO, CH₄, N₂, Ar.

In the description reference will also be made to synthesis gas or “syngas”, meaning by this a gas mixture containing mainly CO₂, CO, H₂O, H₂, CH₄ in any proportion to the gaseous state and other substances including N₂, Ar, O₂, HC (hydrocarbons), HCO (oxygenated hydrocarbons), H₂S, SO₂, NOx and H₂O.

In the description reference will also be made to “corrected syngas” meaning by this the low CO content syngas that has undergone the WGS (Water Gas Shift) process and in which all or most of the CO present in the syngas has reacted with H₂O according to the known reaction:

$$CO + {H}_{2} O →︀ {H}_{2} + {CO}_{2}$$

In the description reference will also be made to “hydrogen” meaning by this a mixture of gas containing mainly hydrogen and other substances including CO, Ar, CO₂, CH₄, N₂, HC and H₂O in a proportion preferably less than 20% by volume while when we intend to refer only to the chemical element H₂ (hydrogen) in the description H₂ will be used.

In the description reference will be made to “pure hydrogen”, thereby meaning the hydrogen as defined above which has been subjected to a purification process. Among the hydrogen purification processes we can mention the polymeric or metal membranes (palladium membranes) or the PSA (Pressure Swing Absorption) processes which allow to obtain hydrogen purities higher than 99.9%.

In the description, reference will be made to “Hydrocarbon Gas” or “HG” meaning any gas containing hydrocarbons with any pressure or temperature, even coming from solid fuel gasifiers or pyrolizers. Hydrocarbons can be gaseous such as the methane, the ethane, the propane, the butane etc. or nebulized or vaporized liquids such as the benzene, the hexane, the octane, etc. Among the “Hydrocarbon Gases” we can mention the natural gas, the biogas, the biomethane, the LNG (Liquefied Natural Gas), the LPG (Liquefied Petroleum Gas), the syngas and the pyrolysis gas. In the specific case that the “Hydrocarbon Gas” is a syngas produced by a gasifier, this is fed to the plant 100 according to the invention at a temperature lower than 500° C., however not sufficient to obtain a calcination of the carbonate.

In the description reference will be made to “HSR” reaction or Hydrocarbon Steam Reforming reaction, meaning by this the known Steam Reforming reaction of hydrocarbons:

$${C}_{n} {H}_{2 n + 2} + {n H}_{2} O →︀ n CO + ( 2 n + 1 ) {H}_{2}$$

that in the particular case where the hydrocarbon is CH₄, the reaction is:

$${CH}_{4} + 3 {H}_{2} O →︀ CO + 3 {H}_{2}$$

and is called the Steam Methane Reforming (SMR) reaction.

In the description reference will be made to “WGS” reaction or Water Gas Shift reaction, meaning by this the known reaction:

$$CO + {H}_{2} O →︀ {H}_{2} + {CO}_{2}$$

In the description reference will be made to “tail gas” meaning by this the gas released by the hydrogen purifier and which has an H₂ content lower than 50%, preferably lower than 20%. Gases such as CH₄, CO, HC, CO₂ and N₂ may also be present in the tail gas.

In the description reference will also be made to “fuel” meaning any liquid, solid or gaseous substance containing carbon such as mineral coal, biomass, natural gas, petroleum, plastics.

In the description reference will also be made to “gasifier” meaning any system, per se known, capable of generating a syngas starting from a fuel. For example, the gasifiers can be of the updraft, downdraft, crossdraft, fluidized bed, mobile grate, rotary kiln, entrained, slagging, pyrolizers type or gasifiers type that exploit solar energy.

In the description reference will also be made to “water”, meaning by this water in the liquid phase with the chemical and temperature characteristics necessary for use in the process according to the invention, while when it is intended to refer only to the chemical element H₂O in the description we will use H₂O.

In the description, reference will also be made to “steam”, thus meaning H₂O in vapor form with the characteristics of temperature and pressure necessary for use in the process according to the invention.

In the description reference will also be made to “sea”, meaning the sea properly said but also the ocean, a lake, a river, a sewer system, a canal or any body of salty or brackish water.

In the description reference will also be made to “carbonate” meaning any sedimentary calcareous or dolomitic rock such as calcite, aragonite, dolomite, siderite, magnesite, marble, but also any other carbonate material such as shells or corals with dimensions between 1 micron and 300 mm, preferably between 100 micron and 100 mm.

In the description, reference will also be made to “electric calciner” (or electric furnace) meaning any electrical system with a controlled atmosphere, known per se, capable of calcining the carbonate according to the reactions CaCO₃→CaO+CO₂ (+183 kj/mol) or MgCO₃→MgO+CO₂ (+118 kj/mol). The calcination process, per se known, takes place at temperatures preferably between 500° C. and 1300° C. depending on the composition of the atmosphere and the pressure present and is an endothermic process in which the energy necessary for calcination and for the HSR it is given by electricity through special electric resistances or induction systems. The controlled atmosphere electric calciner does not allow direct contact of the calcination area with the ambient air while it allows flushing of the calcination area possibly with water vapor.

In the description, reference will also be made to “oxide”, meaning by this the product of the calcination formed mainly by calcium oxide CaO or magnesium MgO and to a lesser extent by other materials (impurities) present in the carbonate rock with which the calciner is fed.

In the description, reference will also be made to “hydroxide”, meaning the hydration product of calcium oxide Ca(OH)₂ or magnesium oxide Mg(OH)₂ with the following chemical reactions:

$$CaO + {H}_{2} O -> {Ca ( OH )}_{2} ( - 64.8 kj / mol )$$

$$MgO + {H}_{2} O -> {Mg ( OH )}_{2} ( - 37. kj / mol )$$

In the description reference will be made to “bicarbonates” meaning by this the chemical compounds Ca(HCO₃)_{2(aq)} and/or Mg (HCO₃)_{2(aq)}

In the description reference will be made to “impurities” meaning by this the foreign substances present in the carbonate which do not take part in the chemical reactions according to the invention.

In the description reference will be made to “contactor”, meaning by this a reactor in which CO₂ and water are reacted according to the reaction CO₂+H₂O→H₂CO₃→H⁺+HCO₃. This contactor can consist of a washing column (scrubber) or a bubbling column, pressurized or atmospheric in which the CO₂ can remain in contact with the water for more than 1 s, preferably between 10 s. and 1000 s and with pressures ranging from 0.5 barₐ to 101 barₐ;

In the description reference will be made to “acidic water” meaning by this the water that has come into contact with CO₂ and whose pH has lowered compared to its initial pH to values typically lower than pH=7, preferably between 4.5 and 6.5.

In the description reference will be made to “buffered acidic water”, thus meaning an acidic water where the pH has been corrected, by adding a hydroxide, to the desired value.

In the description reference will be made to the “Ω_{cal}” meaning by this the calcite saturation state in the sea water.

In the description reference will be made to “pH” meaning by this the measurement scale that indicates the acidity or the basicity of a liquid which is defined by the following formula:

$$pH = - {log}_{10} [ {H}_{3} {O}^{+} ]$$

In the description reference will be made to “alkalinity” meaning by this the quantity of hydroxides OH, carbonates CO₃²⁻ and bicarbonates HCO₃⁻ present in sea water.

In the description reference will be made to the “hardness” meaning by this a value that expresses the total content of Ca²+ and Mg²+ ions present in the sea water.

In the description reference will also be made to the “atmosphere”, meaning by this any place in contact with atmospheric air.

In the description reference will also be made to “high temperature”, meaning by this a temperature greater than 500° C.

In the description, reference will also be made to the concept of “decarbonized”, meaning by this a product or in service that does not involve CO₂ emissions into the atmosphere, i.e. where the CO₂ produced by the production process has been stored permanently.

In the attached Figures, the reference 100 indicates the plant as a whole according to the invention.

A first aspect of the invention relates to a plant 100 for the production of decarbonized hydrogen. With reference to FIG. 1, the plant 100 comprises the electric calciner 10, the contactor 20, the apparatus for correcting the pH 30, a hydroxide production unit 60 and the hydroxide metering device 40 in which:
the electric calciner 10 is suitable for receiving as inlet a flow of carbonate 110, the electricity 120, the steam 620, the “Hydrocarbon Gas” 125 and for releasing as outlet at least one flow of syngas 140 and at least one flow of oxide 130;
the contactor 20 is suitable for receiving as inlet the flow of syngas 140 released by the electric calciner 10, the flow of water 210, is suitable for reacting the water 210 and the CO₂ present in the syngas 140 according to the known reaction CO₂+H₂O→H₂CO₃→H⁺+HCO₃⁻ and for releasing as outlet at least one flow of acidic water 230 and hydrogen 221;
the apparatus for correcting the pH 30 is suitable for receiving as inlet at least one predetermined flow of hydroxide 640 and the flow of acidic water 230, it is suitable for reacting the acidic water 230 with the predetermined flow of hydroxide 640 according to the reaction Ca(OH)₂+2CO₂→Ca (HCO₃)_{2(aq)} (where Ca can be replaced with Mg if present in the carbonate) and for releasing as outlet a flow of buffered acidic water 240;
the hydroxide production unit 60 is suitable for receiving as inlet at least one flow of oxide 130 released by the electric calciner 10, a predetermined flow of water 610, is suitable for making the oxide 130 react with the water 610 according to the reaction CaO+H₂O→Ca(OH)₂(where Ca can be substituted with Mg if present in the carbonate) and for releasing as outlet the flow of hydroxide 630 and a flow of steam 620;
the metering device 40 is suitable for receiving as inlet the flow of hydroxide 630 released by the hydroxide production unit 60 and for releasing as outlet a predetermined flow of hydroxide 640 to feed the apparatus for correcting the pH 30 and possibly a quantity of hydroxide 650 available for other uses.

In accordance with an embodiment of the plant 100 according to the invention and with reference to FIGS. 1, 2, 3, and 4, the plant 100 further comprises:
the water chemical parameter meter 51 which is suitable for measuring the pH and/or alkalinity and/or hardness of the acidic water 230 or the buffered acidic water 240 and providing the measurement to the control unit 50;
the control unit 50 which is adapted to control the metering device 40 so that it feeds to the apparatus for correcting the pH 30 the predetermined flow of hydroxide 640 suitable for obtaining a buffered acid water 240 with a desired pH.

In accordance with an embodiment of the plant 100 and with reference to FIG. 2, the plant 100 described above further comprises a hydrogen purification unit 70 in which:
the hydrogen purification unit 70 is suitable for receiving as inlet the flow of hydrogen 221 released by the contactor 20 and separating it into at least one flow of pure hydrogen 72 and a tail gas 71.

In accordance with an embodiment of the plant 100 and with reference to FIGS. 3 and 4, the plant 100 described above also comprises a WGR unit 90 in which:
the WGS unit is suitable for receiving as inlet the flow of syngas 140 coming from the electric calciner 10, for catalytically converting the CO present into H₂ by means of the known reaction CO+H₂O→CO₂+H₂ and for releasing as outlet at least one flow of corrected syngas 151.

In accordance with an embodiment of the plant 100, the contactor 20 has a volume that allows a contact time of the water 210 with the CO₂ of at least 1 s, preferably between 10 s and 1000 s and an average pressure greater than 0.5 barₐ preferably comprised between 2 barₐ and 101 barₐ.

It should be noted here that the syngas fed to the contactor 20 can be either the syngas (indicated with 140) coming directly from the electric calciner 10 or it can be the corrected syngas (indicated with 151) coming from the WGS unit 90.

A second aspect of the invention relates to a method for the production of decarbonized hydrogen using carbonate, gas containing hydrocarbons and electricity. The method according to the invention comprises the steps of:
providing an electric calciner 10;
feeding to the electric calciner 10 the electrical energy 120 and the flow of carbonate 110 so as to obtain the calcination of the carbonate 110 according to the CaCO₃ reaction→CaO+CO₂ (where Ca can be replaced with Mg if present in the carbonate);
releasing as outlet from the electric calciner 10 the flow of syngas 140 and oxide 130;
conveying the flow of syngas 140;
conveying the flow of oxide 130;
providing a contactor 20;
feeding to the contactor 20 the flow of syngas 140 produced by the electric calciner 10, a predetermined flow of water 210 and carbonate 220 so that the reaction CaCO₃+CO₂+H₂O→Ca(HCO₃)_{2(aq)} can take place (where Ca can be replaced with Mg if present in the carbonate);
releasing the flow of acidic water 230 at the outlet from the contactor 20;
conveying the acidic water 230;
preparing a hydroxide production unit 60;
feeding the flow of oxide 130 and the predetermined flow of water 610 to the hydroxide production unit 60 so that the reaction CaO+H₂O→Ca(OH)₂ can take place (where Ca can be substituted with Mg if present in the carbonate);
releasing at least one flow of hydroxide 630 and a flow of steam 620 at the output of the hydroxide production unit 60;
conveying the flow of hydroxide 630;
providing a metering device 40;
feeding the flow of hydroxide 630 to the metering device 40;
releasing at the outlet from the metering device 40 the predetermined flow of hydroxide 640 and optionally a flow of hydroxide 650 available for other uses;
conveying the predetermined flow of hydroxide 640;
preparing an apparatus for correcting the pH 30;
feeding the flow of acid water 230 and the predetermined flow of hydroxide 640 to the apparatus for correcting the pH 30;
releasing at the outlet of the apparatus for correcting the pH 30 the flow of acidic buffered water 240;
discharging the flow of buffered acidic water 240 into the sea.

According to an embodiment, the method further comprises the steps of:
providing a control unit 50 and a meter of the chemical parameters of the water 51 suitable for measuring the pH and/or alkalinity and/or hardness of the acidic water 230 or of the acidic buffered water 240;
providing the measurement of pH and/or alkalinity and/or hardness from the pH meter 51 to the control unit 50;
controlling the metering device 40 by means of the control unit 50 so that it feeds to the apparatus for correcting the pH 30 the predetermined flow of hydroxide 640 to obtain a buffered acid water 240 with a desired pH.

According to an embodiment, the method further comprises the steps of:
providing a hydrogen purification unit 70;
feeding the hydrogen purification unit with the flow of hydrogen 221 released by the contactor 20;
releasing at least one flow of pure hydrogen 72 and one flow of tail gas 71 at the outlet of the hydrogen purification unit 70.

According to an embodiment, the method further comprises the steps of:
preparing a WGS unit 90;
feeding the WGS unit 90 with the flow of syngas 140 released by the electric calciner 10 so that the WGS reactions can take place according to the reaction CO+H₂O→CO₂+H₂;
releasing at least one flow of corrected syngas 151 as output from the WGS unit 90.

According to an embodiment, the method further comprises the steps of:
conveying the tail gas 71 released by the hydrogen purification unit 70;
feeding the electric calciner 10 with the tail gas 71.

Referring to FIGS. 1, 2, 3, and 4, a skilled person will be able to see that the electric calciner 10 is fed with carbonate 110 and electricity 120 and releases the oxide 130 and the syngas 140. The electric calciner 10 is powered by energy to generate the heat needed for calcination. Electricity can be used in electric heaters, microwave generators or induction systems.

In a form per se known, the calcination of the carbonate 110 takes place according to the CaCO₃ reaction→CaO+CO₂, where Ca can be replaced by Mg if present in carbonate 11, at temperatures between about 500° C. (MgCO₃) and 1300° C. (CaCO₃) and intermediate values depending on the chemical composition of the carbonate which can also be a dolomite CaMg(CO₃)₂ and the chemical composition and pressure of the atmosphere in the calciner.

In a known form, the calcination reaction is an endothermic reaction which requires 118 KJ/mol of heat in the case of the calcination of MgCO₃ and 183 KJ/mol in the case of CaCO₃.

A skilled person can understand that the CO₂ produced by an electric calcination generates a gas formed by CO₂ and traces of non-soluble gases such as N₂ and soluble gases such as O₂ possibly entered with the carbonate 110 inside the electric calciner 10 or gas intentionally fed to the electric calciner 10 to improve the process conditions as in the case of water vapor.

An expert can understand, referring to FIG. 5 and to the particular case of CH4, that a hydrocarbon such as CH₄ heated to a temperature above 400° C. and in the presence of H₂O, dissociates into H₂ and CO according to the well-known reaction CH₄+H₂O→CO+3H₂.

An expert person, always referring to FIG. 5, can therefore deduce that, at a temperature higher than 400° C., if an appropriate quantity of steam were present with the CH₄, with a H₂O/CH₄ ratio between 1 and 10, preferably between 2 and 5, this would be partially reformed producing H₂.

Still referring to FIG. 5, an expert will note that the degree of dissociation of CH₄ into CO and H₂ is a function of temperature.

A skilled person can understand that the known quenching reaction of lime oxide according to the reaction CaO+H₂O→Ca(OH)₂ (where Ca can be replaced with Mg if present in the carbonate), being strongly exothermic, can be used for the production of steam 620.

A skilled person can understand that if the steam 620 produced by the calcium oxide quenching reaction were conveyed inside the calciner it could generate a controlled atmosphere which, by lowering the partial pressure of the CO₂, would favor the calcination reactions and at the same time would favor HSR reactions.

An expert can in fact verify that for non-catalytic SMR reactions it is preferable to have a mol _{H2O}/mol_{CH4} ratio higher than 3 to avoid the formation of soot.

A skilled person can understand that, in the presence of steam 620, the temperature at which the calcination reactions take place, preferably between 500° C. and 1300° C., is similar to that required for HSR reactions, so it is possible that the calcination reactions calcination and the HSR reactions can take place simultaneously in the same reactor which is represented by the electric calciner 10 according to the invention.

A skilled person can also understand that feeding the calciner 10 with the flow of steam 620 coming from the lime oxide quenching reaction instead of with steam coming from outside the plant 100 represents a considerable energy and economic advantage.

With reference to the embodiment of FIG. 1, 2, 3 or 4, the plant 100 according to the invention comprises the contactor 20.

In per se known form, the contactor 20 uses water 210 as a means to hydrate the CO2 from the flow of syngas 140 and form the acidic water 230 according to the reaction:

$${CO}_{2 ( g )} + {H}_{2} O →︀ {H}_{2} {CO}_{3} →︀ {H}^{+} + {HCO}_{{3}^{-}}$$

In known form, there are different types of contactors for absorbing the CO₂ present in a gas which can be divided into washing columns, with or without filling, or bubbling columns.

In a known form, the permanent storage of CO₂ in the form of calcium bicarbonates Ca(HCO₃)₂ in the sea has been proposed in various scientific articles and is considered a form of permanent storage of CO₂ with also a beneficial effect on the acidification of the oceans. as it increases its alkalinity.

An expeienced person will understand that by neutralizing the acidity present in the acidic water 230 with the predetermined flow of hydroxide 640, an effluent with the same natural pH as seawater could be discharged into the sea and all the residual CO₂ in the form of bicarbonates could be stored. according to the reaction Ca(OH)_{2(aq)}+2CO₂→Ca₂⁺+(HCO₃)₂⁻, where the Ca²⁺ ion can be replaced by the Mg²⁺ ion, eliminating environmental problems and obtaining a CO₂ storage efficiency of approximately 100%.

In known form, the reaction of Ca(OH)₂ (where Ca can be replaced by Mg if present in the carbonate) with sea water is a complex reaction due to the presence of other chemical elements and therefore it results that for each mole of Ca(OH)₂ it is possible to neutralize from 1.50 to 1.80 moles of CO₂ instead of the 2 moles foreseen by the equation Ca(OH)_{2(aq)}+2CO₂→Ca(HCO₃)_{2(aq)}. This variability depends on the chemical composition of the water and is inversely proportional to the pressure.

An experienced person will be able to easily verify that it is possible to carry out the process according to the invention mainly using sea water since, while adding considerable quantities of hydroxide 640 to the acidic water 230, it is possible to achieve Ω_{cal} of 25-30 without the carbonate starting to precipitate. This would not be possible in fresh water of rivers or lakes where the pH of the water was higher than about 7 as a precipitation of carbonates would be generated when the 240 buffered acid water is diluted with the surrounding water.

Referring to the embodiment of FIG. 1, 2, 3 or 4, the apparatus 100 according to the invention comprises the apparatus for correcting the pH 30 in which the acidic water 230 is buffered with a predetermined flow of hydroxide 640 sufficient to obtain the desired pH in acidic buffered water 240.

With reference to the embodiment of FIGS. 1, 2, 3 and 4, the apparatus 100 according to the invention is equipped with a meter of the chemical parameters of the water 51 suitable for measuring the pH and/or alkalinity and/or the hardness of the water and of a control unit 50 for managing the metering device 40 which allows the correct predetermined flow of hydroxide 640 to be supplied to the apparatus for correcting the pH 30. The metering device 40 can be a metering pump in as the predetermined flow of hydroxide 640 can be fed to the apparatus for correcting the pH 30 in the form of a slurry or an ionic solution.

An experienced person can surely calculate that the solubility of CO₂ in water depends on the partial pressure of the CO₂ and the temperature of the water. Referring to FIG. 6, the solubility of CO₂ in sea water can be seen as a function of its partial pressure at a temperature of 10° C.

A skilled person can certainly understand that the acidic water 230 released from the contactor 20, if saturated with CO₂, generally has a pH between 5 and 6, lower than the pH of the sea which is about pH 8.

A skilled person will certainly understand that, to avoid acidifying the sea by releasing an acidic water 230, it is necessary to buffer the pH with a basic substance such as the hydroxide 640 and discharge a buffered acid water 240 with the same pH as the sea.

A skilled person will certainly understand that it would also be possible to use other substances to buffer acidic water 230, such as NaOH or KOH, but that their cost would make them not economically convenient.

Referring to FIG. 7, an expert can certainly understand the simplified mass and energy balance of a particular plant 100 for the production of decarbonized hydrogen that uses CH₄ as “Hydrocarbon Gas” 125 and using a H₂O/CH₄ ratio of 3.2:1 where:
the electric calciner 10 is powered by 1,000 kg of carbonate (CaCO₃) 110, 462 kg of steam 620, 128 kg of CH₄ 125 and 1,335 kWe of electricity 120 and releases 1030 kg of syngas 140 and 560 kg of oxide (CaO) 130;
the WGS 90 reactor is fed by 1030 kg of syngas 140 and releases 1030 kg of corrected syngas 151 at the outlet containing about 64 kg of H₂ and 792 kg of CO₂;
the contactor is fed by 2500 tons of water 210, 1030 kg of corrected syngas 151 and releases 2500.96 tons of acidic water 230 with a pH of about 6.2 and 64 kg of hydrogen 221;
the hydroxide production unit 60 is fed by 560 kg of oxide 130 released by the electric calciner 10, by 642 kg of water 610 and releases 740 kg of hydroxide Ca(OH)₂ 630 and 462 kg of steam 620 at the outlet;
the metering device 40 receives at its input 740 kg of hydroxide 630 released from the hydroxide production unit 60 and releases 740 kg of hydroxide 640 at the output to the pH regulation apparatus 30;
the apparatus for correcting the pH 30 receives at its input 2500.96 tons of acidic water 230 released by the contactor 20 and 740 kg of hydroxide 640 released by the metering device 40 and releases 2501.70 tons of 240 buffered acidic water with a pH of 8 exploiting the reaction Ca(OH)_{2(aq)}+2CO₂→Ca(HCO₃)_{2(aq)} where Ca can be replaced by Mg if it is present in the carbonate. In the case of sea water, depending on its chemical composition and depth, 1 mol of Ca(OH)₂ neutralizes 1.50-1.8 moles of CO₂. In the case in question, a ratio of 1.8 moles of CO₂ per mole of Ca(OH)₂ is considered as it is assumed to use a reaction pressure equal to the atmospheric pressure so that the available moles of Ca(OH)₂ 640 are perfectly balanced to buffer all the CO₂ present in the acidic water 230.

As an expert person can understand from the above example, it is always possible to balance the production of hydroxide 630 with the CO2 present in the syngas 140 or in the corrected syngas 151 produced by the calcination process and by the reformation of the hydrocarbons present in the “Hydrocarbon Gas” 125 changing the relationship between steam and hydrocarbon.

As the expert can well calculate using market values, the cost of the ton of decarbonized hydrogen produced with CH4 mainly depends on the cost of carbonate, electricity and CH4 while plant and labor costs marginally affect the result. the final. In particular, approximately 23.8 kWh of electricity, 15.6 kg of carbonate and 2 kg of CH₄ are needed to produce 1 kg of decarbonized hydrogen. If the cost of carbonate were 5 €/ton, the cost of renewable electricity was 50 €/MWh and the cost of CH₄ was 35 €/MWh, the variable cost of decarbonized hydrogen would be 1.96 €/kg.

An expert could therefore calculate that the installation costs of the electric calciner, the contactor, the metering device, the carbonate mill, civil works and services affect about 0.3 €/kg of hydrogen while the personnel costs are negligible. Therefore, considering a final cost of 2.26 €/kg the decarbonized hydrogen produced according to the invention is very competitive on the market with respect to the production cost of hydrogen from electrolysis.

With reference to the embodiment of FIG. 8, the electric calciner 10 according to the invention can comprise an inclined adiabatic tube 11, electrical resistances 1050 and a system 1330 for the controlled discharge of the oxide 130 from the tube 11 to the production unit of hydroxide 60.

The adiabatic inclined tube 11 can be static or rotating and preferably have an inclination of between 0° and 90° with respect to the vertical.

According to a particular embodiment of the calciner 10, the inclined tube 11 can be replaced by one or more rotating tubes such as for example rotary kilns or “rotary kilns”. According to a particular embodiment of the calciner 10, the

inclined tube 11 can be replaced by one or more rotating tubes such as for example rotary kilns or “rotary kilns”.

According to a particular embodiment of the calciner 10 and always referring to FIG. 8, the electrical resistances 1050 can be external to the adiabatic tube 11 or positioned inside it.

As the skilled person may well understand, the flow of steam

620 generated in the hydroxide production unit 60 which enters the electric calciner 10 together with the flow of “Hydrocarbon Gas” 125 (represented by the arrow 1420), passing through the oxide particles 1020 in countercurrent, it is heated while the oxide particles are cooled.

The joint flow of steam and “Hydrocarbon Gas” 1420 reaches the zone of maximum temperature, preferably below 1300° C., in correspondence with the electrical resistances 1050 where the HSR and calcination reactions take place which allow the formation of syngas 1410 at high temperature. The high temperature syngas 1410, passing through the carbonate particles 1010 in countercurrent, is cooled while the carbonate particles are heated.

The high temperature syngas 1410 formed inside the calciner 10 at the electrical resistances 1050, cooled by the carbonate flow, leaves the electric calciner as syngas 140 at a temperature below 1000° C., preferably between 200°° C. and 800° C.

As the skilled person may well understand, the carbonate particles 1010 are preheated by the flow of high temperature syngas 1410 which cross them against the current while the high temperature oxide particles 1020 are cooled by the joint flow of steam and “Hydrocarbon Gas” 1420 which it crosses them in countercurrent at a temperature above 400° C., preferably between 580° C. and 800° C., allowing high energy efficiency in the calcination and HSR process.

As an expert can surely understand, the decarbonized hydrogen production process according to the invention allows to permanently store CO2 in the sea in the form of bicarbonates at a cost competitive with the cost of geological CCS and above all to be able to install modular systems for small size distributed on the coasts of many countries.

As an expert can surely understand, if the “Hydrocarbon Gas” 125 came from biogas or biomass gasification, H₂ and negative emissions could be generated with small plants without having to have expensive CCS geological storage systems.

As one can surely understand, the availability of carbonate, water, “Hydrocarbon Gas” and renewable electricity are not limiting to producing enough decarbonized hydrogen to meet demand in the global energy transition period.

As the skilled person can well conclude, the method and the plant according to the invention allow to produce decarbonized hydrogen: it is thus possible to overcome one of the most important technical/economic obstacles for the production of decarbonized hydrogen due to the lack of permanent storage sites. of CO₂ and for the generation of negative emissions all over the world and at competitive costs.

It is clear that the specific characteristics are described in relation to different embodiments of the plant and of the method with an illustrative and non-limiting intent. Obviously, a person skilled in the art, in order to meet contingent and specific needs, may make further modifications and variations to the plant and method according to the present invention, all of which are however contained within the scope of protection of the invention, as defined by the following claims.

1. Plant for the production of decarbonized hydrogen using carbonate, gas containing hydrocarbons and electricity which includes the electric calciner, the contactor, the apparatus for pH correction and the dosing device in which:
the electric calciner is suitable for receiving as inlet a flow of carbonate, the electricity, the steam, the “Hydrocarbon Gas” and for releasing as outlet at least one flow of syngas and at least one flow of oxide;
the contactor is suitable for receiving as inlet the flow of syngas released by the electric calciner, the flow of water, is suitable for reacting the water and the CO₂ present in the syngas according to the known reaction CO₂+H₂O→H₂CO₃→H⁺+HCO₃⁻ and for releasing as outlet at least one flow of acidic water and hydrogen;
the apparatus for correcting the pH is suitable for receiving as inlet at least one predetermined flow of hydroxide and the flow of acidic water, it is suitable for reacting the acidic water with the predetermined flow of hydroxide according to the reaction Ca(OH)₂₊₂CO₂→Ca(HCO₃)_{2 (aq)}(where Ca can be replaced with Mg if present in the carbonate) and for releasing as outlet a flow of buffered acidic water;
the hydroxide production unit is suitable for receiving as inlet at least one flow of oxide released by the electric calciner, a predetermined flow of water, is suitable for making the oxide react with the water according to the reaction CaO+H₂O→Ca(OH)₂ (where Ca can be substituted with Mg if present in the carbonate) and for releasing as outlet the flow of hydroxide and a flow of steam;
the metering device is suitable for receiving as inlet the flow of hydroxide released by the hydroxide production unit and for releasing as outlet a predetermined flow of hydroxide to feed the apparatus for correcting the pH and possibly a quantity of hydroxide available for other uses.

2. A plant according to claim 1 which comprises a control unit and a meter of the chemical parameters of the water in which:
the water chemical parameter meter which is suitable for measuring the pH and/or alkalinity and/or hardness of the acidic water or the buffered acidic water and providing the measurement to the control unit;
the control unit which is adapted to control the metering device so that it feeds to the apparatus for correcting the pH the predetermined flow of hydroxide suitable for obtaining a buffered acid water with a desired pH.

3. A plant according to claim 1 which comprises a hydrogen purification unit wherein:
the hydrogen purification unit is suitable for receiving as inlet the flow of hydrogen released by the contactor and separating it into at least one flow of pure hydrogen and a tail gas.

4. A plant according to claim 1 which further comprises a WGR unit (in which:
the WGS unit is suitable for receiving as inlet the flow of syngas coming from the electric calciner, for catalytically converting the CO present into H₂ by means of the known reaction CO+H₂O→CO₂+H₂ and for releasing as outlet at least one flow of corrected syngas.

5. A plant according to claim 1 in which the contactor has a volume that allows a contact time of the water with the CO₂ of at least 1 s, preferably between 10 s and 1000 s and an average pressure greater than 0.5 barₐ preferably comprised between 2 barₐ and 101 barₐ.

6. Method for the production of decarbonized hydrogen using carbonate, gas containing hydrocarbons and electricity. The method according to the invention comprises the steps of:
providing an electric calciner;
feeding to the electric calciner the electrical energy and the flow of carbonate so as to obtain the calcination of the carbonate according to the CaCO₃ reaction→CaO+CO₂ (where Ca can be replaced with Mg if present in the carbonate);
releasing as outlet from the electric calciner the flow of syngas and oxide;
conveying the flow of syngas;
conveying the flow of oxide;
providing a contactor;
feeding to the contactor the flow of syngas produced by the electric calciner, a predetermined flow of water and carbonate (220) so that the reaction CaCO₃+CO₂+H₂O→Ca(HCO₃)_{2(aq)} can take place (where Ca can be replaced with Mg if present in the carbonate);
releasing the flow of acidic water at the outlet from the contactor;
conveying the acidic water;
preparing a hydroxide production unit;
feeding the flow of oxide and the predetermined flow of water to the hydroxide production unit so that the reaction CaO+H₂O→Ca(OH)₂ can take place (where Ca can be substituted with Mg if present in the carbonate);
releasing at least one flow of hydroxide and a flow of steam at the output of the hydroxide production unit;
conveying the flow of hydroxide;
providing a metering device;
feeding the flow of hydroxide to the metering device;
releasing at the outlet from the metering device the predetermined flow of hydroxide and optionally a flow of hydroxide available for other uses;
conveying the predetermined flow of hydroxide;
preparing an apparatus for correcting the pH;
feeding the flow of acid water and the predetermined flow of hydroxide to the apparatus for correcting the pH;
releasing at the outlet of the apparatus for correcting the pH the flow of acidic buffered water;
discharging the flow of buffered acidic water into the sea.

7. Method for the production of decarbonized hydrogen using carbonate, gas containing hydrocarbons and electricity respectively according to claim 6 which further comprises the steps of:
providing a control unit and a meter of the chemical parameters of the water suitable for measuring the pH and/or alkalinity and/or hardness of the acidic water or of the acidic buffered water;
providing the measurement of pH and/or alkalinity and/or hardness from the pH meter to the control unit;
controlling the metering device by means of the control unit so that it feeds to the apparatus for correcting the pH the predetermined flow of hydroxide to obtain a buffered acid water with a desired pH.

8. Method for the production of decarbonized hydrogen using carbonate, gas containing hydrocarbons and electricity respectively according to any preceding claim 6 which further comprises the steps of:
providing a hydrogen purification unit;
feeding the hydrogen purification unit with the flow of hydrogen released by the contactor;
releasing at least one flow of pure hydrogen and one flow of tail gas at the outlet of the hydrogen purification unit.

9. Method for the production of decarbonized hydrogen using carbonate, gas containing hydrocarbons and electricity respectively according to claim 6 which further comprises the steps of:
preparing a WGS unit;
feeding the WGS unit with the flow of syngas released by the electric calciner so that the WGS reactions can take place according to the reaction CO+H₂O→CO₂+H₂;
releasing at least one flow of corrected syngas as output from the WGS unit.

10. Method for the production of decarbonized hydrogen using carbonate, gas containing hydrocarbons and electricity respectively according to any preceding claim 6 which further comprises the steps of:
conveying the tail gas released by the hydrogen purification unit;
feeding the electric calciner with the tail gas.
